(19) United States
(12) Patent Application Publication
(10) Pub. No.: US 2003/0122665 A1
(43) Pub. Date: Jul. 3, 2003

(54) Remote doorbell ringer

(76) Inventor: Roberto Kaje, Hyattsville, MD (US)

Correspondence Address: Roberto Kaje, 5804 Queens Chapel Road Apt#3, Hyattsville, MD, 20782, US

(21) Appl. No.: 10/033,214

(22) Filed: Dec. 27, 2001

(51) Int. Cl. G08B 1/00

(52) U.S. Cl. 340/531; 398/111; 340/825.72

(57) ABSTRACT

A remote control device when actuated by a user transmits a visually perceptible signal to a sensor associated with a doorbell, or any device compatible with the remote/sensor apparatus (e.g. garage door, spot-light, etc.). Whence the signal is visually verified to be in alignment with the sensor the remote confirms and then executes the device via an activation signal and other information from the remote. Because the nature of the remote/sensor apparatus is intended to be universal (one remote control can operate any compatible device) the sensor and/or the device intended to be activated may have multiple settings consisting of, but not limited to public (any compatible remote may operate the device), private (only a specified remote may operate the device), and off (no remote may operate the device).

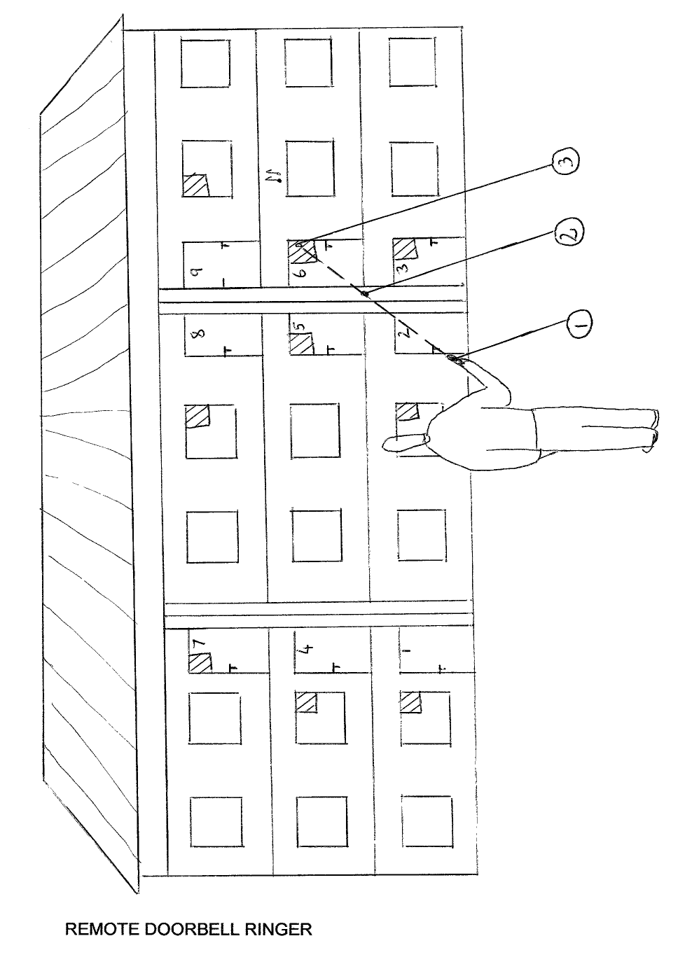

### 2) CROSS-REFERENCE TO THE RELATED APPLICATIONS

| | | US INVENTOR | |
|---|---|---|---|
| PATENT | DATE | OR COUNTRY | TITLE |
| 3,795,896 | Mar. 5, 1974 | Isaacs | Wireless Alarm System |
| 4,236,147 | Nov. 25, 1980 | Calvin | Automatic Doorbell |
| 4,523,193 | Jun. 11, 1985 | Levison et al | Remote-controlled Doorbell |
| | | | Signal Receiver |
| 4,924,214 | May, 8, 1990 | Hill | Door Mat alarm |
| 5,612,666 | Mar. 18, 1997 | Xydis | Wireless Audible Indications |
| | | | System |
| 5,748,074 | May 5, 1998 | Chomet | Electronic Door Chime |
| 5,757,305 | May 26, 1998 | Xydis | Transmitter for wireless |
| | | | Audible Indications System |
| US 6,208,238,B1 | Mar 27, 2001 | Ohta | Electromagnetic Sound |
| | | | Generating Body |
| 2 605 775 | Apr. 29, 1988 | France | Removable audible Warning |
| | | | device intended to be |
| | | | mounted on a Door |
| DE 195 43 365 A1 | May 22, 1997 | Germany | Ringing Circuit with Automatic |
| | | | Volume Control for |
| | | | Radiotelephone, Doorbell or |
| | | | Alarm |
| EP 0 836 150 A1 | Apr. 15, 1998 | Europe | Remote Activation System |
| 2 796 237 | Jan. 12, 2001 | France | Remote house/flat doorbell |
| | | | unit has front door plate . . . |

### 3) BACKGROUND OF THE INVENTION

This invention is a “REMOTE DOORBELL RINGER” that can replace or provide additional functionality to a house, an apartment or an office doorbell because of the following.

Since the invention of the doorbell ringer, there have been inventions associated with the remote operation of the “doorbell ringer” but none with my invention functionality, including:

(1) U.S. Pat. No. 3,795,896 of Mar. 5, 1974 “wireless Alarm System” for home and office which includes transmitter and receiver assemblies.

(2) U.S. Pat. No. 4,236,147 of Nov. 25, 1980 “Automatic Doorbell” relates to a method for detecting the approach of a person on the outside of a closed door and producing a pleasing tone on the inside of the door when such an approach is detected, adaptable to function as automatic doorbell.

(3) U.S. Pat. No. 4,523,193 of Jun. 11, 1985 “Remote-Controlled Doorbell Signal Receiver”. A transmitter for generating an over-the-air radio signal is coupled across the wired doorbell so that the transmitter will be actuated in response to current flowing through the wired doorbell. A remote receiver coupled to sound producing means receives the over-the-air radio signal and actuates the sound producing means when the existing doorbell is energized.

(4) U.S. Pat. No. 4,924,214 of May 08, 1990 “Door Mat Alarm” is set forth including a flexible mat and encapsulated pressure switches positioned in a matrix throughout the mat whereupon compression of the flexible mat relays pressure to the switches and activated a remotely positioned transmitter to actuate an alarm. A modification of the invention includes a transmitter encapsulated adjacent a forward edge of the mat to relay a signal to a remote receiver portably carried by an individual.

(5) U.S. Pat. No. 5,748,074 of May 10, 1998 “Electronic Door Chime” relates to an Electro-mechanical door chime which is activated by a remote door-mounted switch and radio transmitter.

(6) Patent # DE 19543365 “Ringing circuit with automatic volume control for radiotelephone, doorbell or alarm” is an intelligent call system which has a switching circuit for switching call signal generator between different volume levels in dependence on the range and the ambient noise level, provided by IR sensors and a microphone. Preferably, a harmonic volume regulation is effected in dependence on the distance of the user provided by a number of IR sensors, detecting body heat and the ambient noise detected by the microphone, using a transistor switch.

(7) European Patent EP 0 836 150 A1 of Apr. 15, 1998 “Remote Activation System” to be used e.g. by disabled persons who lack the capacity of using their hands to the normal operation of a keyboard, comprises a laser pointer which the disabled operator may support on his head by means of a headrest and /or a mouse which include light sensitive devices associated to each key or function, whereby the laser beam produced by the laser pointer may be directed to anyone of the light receiving devices which are included in an electronic circuit such as to simulate mechanical pressing of any individual key or the rolling operation of a real computer mouse. The same remote activation system may also be used for operating a telephone, a lamp, a household appliance, a door, a window or a water spigot.

(8) France Patent FR2605775 of Apr. 29, 1998 “Removable audible warning device intended to be mounted on a door”, includes a removable U-shaped support capable of being slipped over the edge of the leaf of the door.

France Patent FR2796237 of Jan. 12, 2001 “Remote house/flat door bell unit has front door plate with doorbell ringer/two way speech interchange and roving wireless response unit providing householder interaction/door opening”. The doorbell unit has a base station mounted on the wall where the front door is, and relaying door chimes and speech using a radio signal. The house owner has a mobile responder which allows the caller to speak to the house owner, and to activate door opening.

With all inventions above, the following problems still need to be solved. If the neighbors have the same doorbell system, is it possible to activate only one doorbell at a time without causing disturbing activations of other doorbells with the same remote?

By answering the above question, this invention will reduce the use of alternative means such as (for example) using an automobile horn to get the attention of people who are inside a house, eliminating this type of undesirable noise from neighborhoods. And it could be used by everybody, including delivery services. When the invention is used in “private mode” only persons having the “select remote” could activate the doorbell, ensuring the privacy of the owner of the doorbell ringer.

### 4) BRIEF SUMMARY OF THE INVENTION

When activated by the user pressing a switch, the remote control device sends a low powered laser light to the sensor such that the remote user will see the laser on the sensor before pressing the remote control device switch (again) to confirm and execute the doorbell activation through the invention's sensor apparatus and connection to the doorbell.

### 5) DETAILED DESCRIPTION OF THE INVENTION

1) The remote (1) will be universal such that one remote control device can operate any compatible doorbell that is modified to detect laser light per this invention. Because it will be widely used, the remote also needs to be selective, which is why the invention employs a laser light (2) as the medium to connect the remote control device (send a signal) to the selected doorbell sensor.

2) The sensor (3) will be mounted on and displayed in the front of the building (e.g., near a house number/address sign, door or window, etc.). When activated by the user pressing a switch, the remote control device sends a low powered laser light to the sensor such that the remote user will see the laser on the sensor before pressing the remote control device switch (again) to confirm and execute the doorbell activation through the invention's sensor apparatus and connection to the doorbell.

3) When the doorbell receives the activation signal (e.g., power switch closure) and other possible information from this sensor (as applicable), it is activated as originally designed, such as if its standard doorbell switch had been pressed.

The doorbell needs to be connected to this sensor apparatus, and either the doorbell or the sensor (or both) could have a switch (es) to select one of 3 (or more) options:

1) Public: When in this position, the sensor and thus the doorbell can be activated by any compatible remote control device, as designed and specified under this invention.

2) Private: The sensor and doorbell are activated only by one or more user-specified remote control device(s) using a private code or signal.

3) Off: The doorbell cannot be activated by the invention's remote doorbell ringer device.

The unique features and benefits of this Universal Remote Activated Doorbell are follows:

1) The remote control device(s) and sensor activation device(s) are universal for all design-compatible doorbells, meaning that a range of specific models or designs for these components is possible.

2) On private mode only the selected remote control device could activate the doorbell. On public mode any compatible remote control device could activate the doorbell.

### 6) BRIEF DESCRIPTION OF THE DRAWING

(1) Is the remote control device that produces and sends the signal (laser light).

(2) Is the perceptible signal (laser beam) between the remote and the sensor

(3) The sensor will display a reflection and/or a response signal light so that the user can see the signal is on it before executing the doorbell activation by pressing the remote switch again.

What I claim as my invention is a Remote Doorbell Ringer system wherein the users are able to operate (see diagram above).

1: Any supported and compatible equipment (e.g., doorbell ringer, automatic door, automatic barrier for buildings, machine, spot light), which comprises or includes the (3) laser light sensor can be activated by any compatible (1) remote device. The (1) remote described needs to be universal: the same remote could be used to activate any compatible equipment.

2: The compatible equipment in claim 1 needs to have a sensor on display where the laser beams for the remote will focus. By this way only the desired equipment would be activated.

3: The compatible equipment in claim 2 will also have least 2 modes:
Public mode: Can be activated by any compatible remote (delivery men, visitors and family).
Private mode: Can be activated only by persons having the correct code to activate the sensor to activate or trip a doorbell ringer, a garage door opener, lights, or any other device that could be activated remotely.
